(19) United States
(12) Patent Application Publication
(10) Pub. No.: US 2025/0247601 A1
(43) Pub. Date: Jul. 31, 2025

(54) ELECTRONIC APPARATUS, IMAGE PROCESSING METHOD, AND STORAGE MEDIUM

(71) Applicant: CANON KABUSHIKI KAISHA, Tokyo (JP)

(72) Inventor: SHOHEI FUNAMOTO, Tokyo (JP)

(21) Appl. No.: 19/024,271

(22) Filed: Jan. 16, 2025

(30) Foreign Application Priority Data
Jan. 30, 2024 (JP) 2024-012176
Apr. 16, 2024 (JP) 2024-066307

(51) Int. Cl. H04N 23/611; G06T 7/20; G06T 7/70; H04N 23/60

(52) U.S. Cl. CPC H04N 23/611; G06T 7/20; G06T 7/70; H04N 23/64; G06T 2207/30196

(57) ABSTRACT

An electronic apparatus comprises: a first detection unit that detects one or more subjects from images obtained by performing shooting repeatedly; a determination unit that determines whether each of the subjects detected by the first detection unit is in a predetermined motion state; a selection unit that selects one of the subjects detected by the first detection unit as a main subject; and a control unit that, in a case where the subject determined to be in the motion state by the determination unit is selected as the main subject by the selection unit, restricts a change of the main subject in subsequent images.

### BACKGROUND OF THE INVENTION

### Field of the Invention

The present invention relates to an electronic apparatus, an image processing method, and a storage medium, and more particularly to a subject detection technique in an electronic apparatus.

### Description of the Related Art

Conventionally, in image capturing apparatuses such as digital cameras, a technique has been proposed for detecting a subject from a captured image and performing shooting control such as focus adjustment and exposure control for the detected subject. Some image capturing apparatuses equipped with such a technique have a function of assisting a user in shooting operations by automatically selecting a main subject from among the detected subjects when a plurality of subjects are detected from the captured image.

For example, Japanese Patent Laid-Open No. 2021-071794 discloses a technology for selecting a main subject by acquiring posture information of a plurality of subjects detected from a captured image and calculating the likelihood of the subjects being the main subject based on the posture information.

However, in the conventional technology disclosed in Japanese Patent Laid-Open No. 2021-071794, in a case where postures of a plurality of subjects indicate high likelihood being the main subject, when the likelihood being the main subject changes due to the change in posture, the subject selected as the main subject may frequently change among the plurality of subjects. As a result, the main subject in the shooting scene may not be determined, and stable shooting may not be performed. On the other hand, simply restricting the change of the main subject to avoid this will reduce the responsiveness of the change of the main subject to another subject when a certain subject is in a state with a high likelihood being the main subject.

### SUMMARY OF THE INVENTION

The present invention has been made in consideration of the above situation, and in a case where a plurality of subjects take postures that represent high likelihood being the main subject, the present invention prevents frequent change of the main subject while suppressing a decrease in responsiveness to change of the main subject.

According to the present invention, provided is an electronic apparatus comprising one or more processors and/or circuitry which function as: a first detection unit that detects one or more subjects from images obtained by performing shooting repeatedly; a determination unit that determines whether each of the subjects detected by the first detection unit is in a predetermined motion state; a selection unit that selects one of the subjects detected by the first detection unit as a main subject; and a control unit that, in a case where the subject determined to be in the motion state by the determination unit is selected as the main subject by the selection unit, restricts a change of the main subject in subsequent images.

Further, according to the present invention, provided is an image processing method comprising: detecting one or more subjects from images obtained by performing shooting repeatedly; determining whether each of the detected subjects is in a predetermined motion state; selecting one of the detected subjects as a main subject; and in a case where the subject determined to be in the motion state is selected as the main subject, restricting a change of the main subject in subsequent images.

Furthermore, according to the present invention, provided is a non-transitory computer-readable storage medium, the storage medium storing a program that is executable by the computer, wherein the program includes program code for causing the computer to function as an electronic apparatus comprising: a first detection unit that detects one or more subjects from images obtained by performing shooting repeatedly; a determination unit that determines whether each of the subjects detected by the first detection unit is in a predetermined motion state; a selection unit that selects one of the subjects detected by the first detection unit as a main subject; and a control unit that, in a case where the subject determined to be in the motion state by the determination unit is selected as the main subject by the selection unit, restricts a change of the main subject in subsequent images.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating an example of a functional configuration of a digital camera system according to a first embodiment of the present invention.

FIGS. 2A and 2B are diagrams illustrating an example of correspondence relationship between exit pupils and photoelectric conversion units according to the first embodiment.

FIGS. 3A and 3B are schematic diagrams illustrating examples of configurations of a gaze detection unit according to the first embodiment.

FIG. 4 is a diagram illustrating a sensitivity setting window for changing subject by action determination according to the first embodiment.

FIG. 5 is a flowchart illustrating a procedure for a shooting preparation operation and a continuous shooting operation according to the embodiment.

FIG. 6A is a block diagram illustrating a functional configuration of an image processing unit in main subject region setting processing according to the first embodiment.

FIG. 6B is a diagram illustrating an example of integrated detection information.

FIG. 7 is a flowchart illustrating a procedure of main subject region setting processing according to the first embodiment.

FIGS. 8A and 8B are diagrams illustrating examples of results of subject tracking processing, characteristic object detection processing, and subject detection processing according to the first embodiment.

FIGS. 9A and 9B are diagrams illustrating an example of action determination processing according to the first embodiment.

FIG. 10 is a table for explaining priority levels of subject feature regions according to the first embodiment.

FIG. 11 is a flowchart illustrating a procedure of main subject region determination processing according to the first embodiment.

FIG. 12 is a diagram illustrating a specific example of the main subject region determination processing according to the first embodiment.

FIG. 13 is a flowchart illustrating a procedure of main subject region determination processing according to a second embodiment.

FIG. 14 is a flowchart illustrating a procedure of main subject region determination processing according to a modification.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

In the following embodiment, the present invention will be described with respect to a case where the present invention is implemented as a lens-interchangeable digital camera. However, the present invention may be applied to any electronic apparatus that can be equipped with a subject detection function and a shooting function. Such electronic apparatuses include video cameras, computer devices (personal computers, tablet computers, media players, PDAs, etc.), mobile phones, smartphones, game consoles, robots, drones, dashboard cameras, etc. Note that these are merely examples, and the present invention can be applied to other electronic apparatuses. The present invention may also be applied to a configuration in which the subject detection function and the shooting function are provided in separate devices (for example, a main body and a remote controller) that can communicate with each other.

### First Embodiment

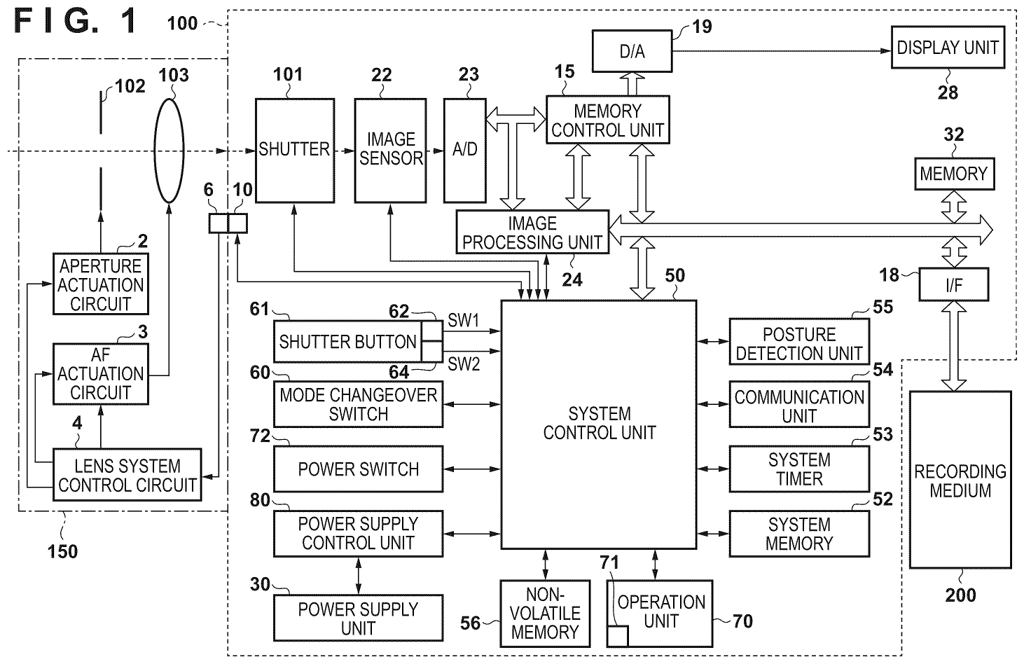

FIGS. 1, 2A and 2B, 3A and 3B are diagrams illustrating an example of the functional configuration of a digital camera system as an example of an electronic apparatus according to an embodiment of the present invention. The digital camera system is constituted of a main body 100 of the digital camera with interchangeable lenses and a lens unit 150 that is detachable from the main body 100. The main body 100 and the lens unit 150 may be configured as an integrated unit.

The lens unit 150 has a communication terminal 6 that comes into contact with a communication terminal 10 provided on the main body 100 when attached to the main body 100. Power is supplied from the main body 100 to the lens unit 150 through the communication terminal 10 and the communication terminal 6. In addition, a lens system control circuit 4 and a system control unit 50 of the main body 100 can communicate bidirectionally through the communication terminal 10 and the communication terminal 6.

In the lens unit 150, a lens group 103 is an imaging optical system composed of a plurality of lenses including a movable lens. The movable lens includes at least a focus lens. Depending on the lens unit 150, one or more of a variable magnification lens and a shake correction lens may further be included. An AF actuation circuit 3 includes a motor, an actuator, etc. that actuate the focus lens. The focus lens is actuated by the lens system control circuit 4 controlling the AF actuation circuit 3. An aperture actuation circuit 2 includes a motor, an actuator, etc. that actuate an aperture 102. The opening amount of the aperture 102 is adjusted by the lens system control circuit 4 controlling the aperture actuation circuit 2.

A mechanical shutter 101 is actuated by the system control unit 50 and adjusts the exposure period of an image sensor 22. A mechanical shutter 101 is kept fully open during moving image shooting.

The image sensor 22 is, for example, a CCD image sensor or a CMOS image sensor. The image sensor 22 has a plurality of pixels arranged two-dimensionally, and each pixel is provided with one microlens, one color filter, and one or more photoelectric conversion units. In this embodiment, each pixel is provided with a plurality of photoelectric conversion units, and is configured so that a signal can be read out from each photoelectric conversion unit. By configuring the pixels in this way, it is possible to generate a captured image and a parallax image pair from the signal read out from the image sensor 22.

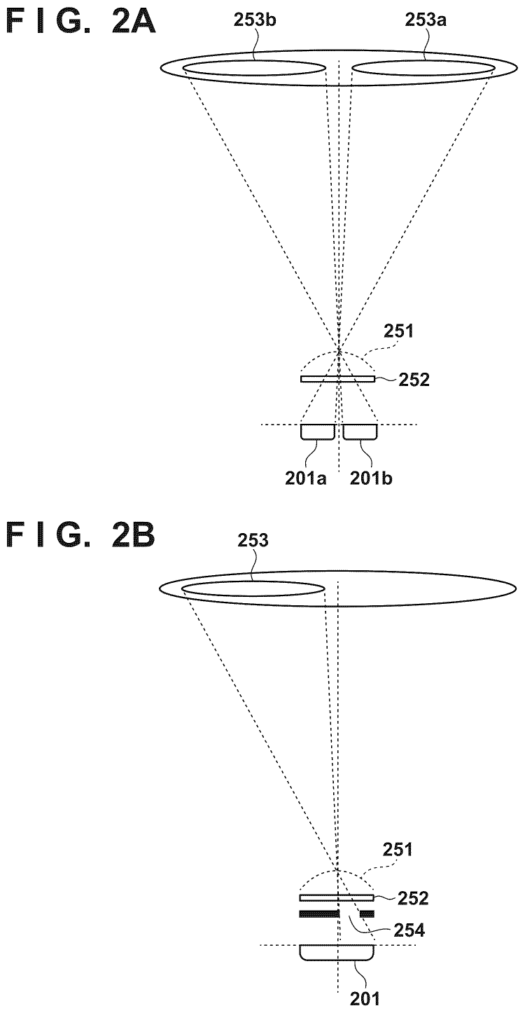

FIG. 2A is a diagram schematically showing the correspondence between the exit pupil of the lens unit 150 and each photoelectric conversion unit when a pixel constituting the image sensor 22 has two photoelectric conversion units.

Two photoelectric conversion units 201a and 201b provided in each pixel share one color filter 252 and one microlens 251. Light that has passed through a partial region 253a of the exit pupil is incident on the photoelectric conversion unit 201a, and light that has passed through a partial region 253b of the exit pupil is incident on the photoelectric conversion unit 201b.

Therefore, for a pixel included in a certain pixel region, an image formed by a signal read from the photoelectric conversion units 201a and an image formed by a signal read from the photoelectric conversion units 201b form a parallax image pair. The parallax image pair can be used as image signals (A image signal and B image signal) for phase difference AF, and a normal image signal (captured image) can be obtained by adding the signals read from the photoelectric conversion units 201a and 201b for each pixel.

In this embodiment, each pixel of the image sensor 22 functions as both a pixel for generating a signal for phase difference AF (focus detection pixel) and a pixel for generating a normal image signal (imaging pixel). However, some pixels of the image sensor 22 may be configured specifically for focus detection, and other pixels may be used as imaging pixels. FIG. 2B shows an example of the configuration of a focus detection pixel and an example of an area 253 of an exit pupil through which incident light passes. The focus detection pixel having the configuration shown in FIG. 2B functions in the same manner as the photoelectric conversion unit 201b in FIG. 2A. In practice, by distributing the focus detection pixels having the configuration shown in FIG. 2B and another type of focus detection pixel that functions in the same manner as the photoelectric conversion unit 201a in FIG. 2A throughout the image sensor 22, it becomes possible to set a focus detection area of substantially any location and size.

The pixels having the configurations shown in FIGS. 2A and 2B are for an image sensor that obtains an image for recording to be also used as a sensor for phase difference AF, but the present invention does not depend on the AF method as long as a focus detection area of variable size and position can be used. For example, the present invention can be implemented even with a configuration that uses contrast AF. In a case where only contrast AF is used, each pixel has one photoelectric conversion unit.

In FIG. 1, an A/D converter 23 is used to convert an analog image signal output from the image sensor 22 into a digital image signal (image data). The A/D converter 23 may be provided in the image sensor 22.

The image data (RAW image data) output from the A/D converter 23 is processed by an image processing unit 24 as necessary, and then stored in a memory 32 via a memory control unit 15. The memory 32 is used as a buffer memory for temporarily storing image data and audio data, and as a video memory for a display unit 28.

The image processing unit 24 applies predetermined image processing to image data, generates signals and image data, and acquires and/or generates various information. The image processing unit 24 may be a dedicated hardware circuit such as an ASIC designed to realize a specific function, or may be configured to realize a specific function by a processor such as a DSP executing software.

The image processing applied by the image processing unit 24 includes pre-processing, color interpolation processing, correction processing, detection processing, data processing, evaluation value calculation, etc. The pre-processing includes signal amplification, reference level adjustment, defective pixel correction, etc. The color interpolation processing is processing for interpolating values of color components not included in the image data, and is also called demosaic processing. The correction processing includes white balance adjustment, image brightness correction, optical aberration correction of the lens unit 150, color correction, etc.

The detection processing is processing for detecting a feature region in an image. The feature region is a subject region that can be detected by a known technique, such as the pupil, face, head, torso, upper body, lower body, or whole body region of a person or animal, a vehicle, an object specific to a scene, an arbitrary object region, or a region with high consistency in pattern matching. Alternatively, only detection of a candidate feature region may be performed. The detection processing also includes an action determination processing that estimates the posture of a detected person and determines whether the person is performing a specific action in a sports competition, such as a shot in a soccer or a spike in a volleyball.

The data processing includes scaling, encoding and decoding, header information generation, etc. The evaluation value calculation includes calculation of a pair of image signals for phase difference AF, evaluation values for contrast AF, evaluation values used for automatic exposure control, etc. Note that these are examples of image processing that can be performed by the image processing unit 24, and do not limit the image processing performed by the image processing unit 24. Furthermore, the evaluation value calculation may be performed by the system control unit 50.

A D/A converter 19 generates an analog signal suitable for display in the display unit 28 from the image data for display stored in the memory 32, and supplies the analog signal to the display unit 28. The display unit 28 has, for example, a liquid crystal display device, and performs display based on the analog signal from the D/A converter 19.

By repeatedly shooting and sequentially displaying images obtained, the display unit 28 can function as an electronic viewfinder (EVF). A moving image displayed to make the display unit 28 function as an EVF will be called a live view image, hereinafter. The display unit 28 may be provided inside the main body 100 so as to be observed through an eyepiece, or may be provided on the surface of the housing of the main body 100 so as to be observed without using an eyepiece. Alternatively, the display unit 28 may be provided both inside the main body 100 and on the surface of the housing.

The system control unit 50 is, for example, a CPU (also called an MPU or microprocessor). The system control unit 50 reads a program stored in a non-volatile memory 56 into a system memory 52 and executes it to control the operation of the main body 100 and the lens unit 150, thereby realizing the functions of the camera system. The system control unit 50 controls the operation of the lens unit 150 by transmitting various commands to the lens system control circuit 4 through communication via the communication terminal 10 and the communication terminal 6.

The non-volatile memory 56 may be rewritable. The non-volatile memory 56 stores programs executed by the system control unit 50, various setting values of the camera system, image data for a graphical user interface (GUI), etc. The system memory 52 is a main memory used when the system control unit 50 executes programs.

As part of its operation, the system control unit 50 performs automatic exposure control (AE) processing based on evaluation values generated by the image processing unit 24 or by itself, and determines the shooting conditions. For example, shooting conditions for still image shooting are shutter speed, aperture value, and ISO sensitivity. The system control unit 50 determines one or more of the shutter speed, aperture value, and ISO sensitivity according to a set AE mode. The system control unit 50 controls the aperture value (aperture) of the aperture mechanism of the lens unit 150. The system control unit 50 also controls the operation of the mechanical shutter 101.

In addition, the system control unit 50 actuates the focus lens of the lens unit 150 based on the evaluation value or defocus amount generated by the image processing unit 24 or by itself, and performs autofocus (AF) processing to control the lens group 103 to focus on a subject within the focus detection area.

A system timer 53 is a built-in clock used by the system control unit 50.

An operation unit 70 includes a plurality of input devices (buttons, switches, dials, etc.) that can be operated by the user. Some of the input devices of the operation unit 70 have names according to the functions assigned to them. For convenience, a shutter button 61, a mode changeover switch 60, and a power switch 72 are illustrated separately from the operation unit 70, but are included in the operation unit 70. If the display unit 28 is a touch display, a touch panel is also included in the operation unit 70. The operation of the input devices included in the operation unit 70 is monitored by the system control unit 50. When the system control unit 50 detects an operation of an input device, it executes a process according to the detected operation.

The shutter button 61 has a first shutter switch 62 (SW1) that is turned on when pressed halfway, and a second shutter switch 64 (SW2) that is turned on when fully pressed. When the system control unit 50 detects that SW1 is turned on, it executes a preparation operation for still image shooting. The preparation operation includes AE processing and AF processing. Further, when the system control unit 50 detects that SW2 is turned on, it executes a still image shooting and recording operation according to the shooting conditions determined by the AE processing.

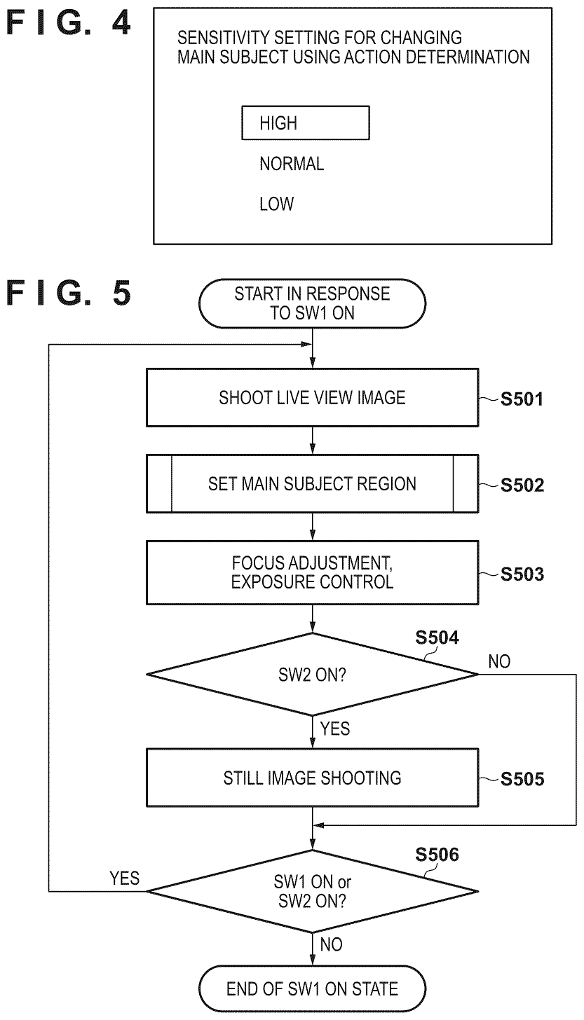

The mode changeover switch 60 is an operation device for switching settings in subject selection. FIG. 4 shows an example of a setting screen for switching the sensitivity setting for main subject selection using action determination processing described later set by the mode changeover switch 60. The sensitivity setting can be selected from three levels: high, normal, and low.

The operation unit 70 of this embodiment also has a gaze detection unit 71 that detects the gaze direction of the user. The gaze detection unit 71 is not a component that is directly operated by the user, but is included in the operation unit 70 because the gaze direction detected by the gaze detection unit 71 is handled as an input.

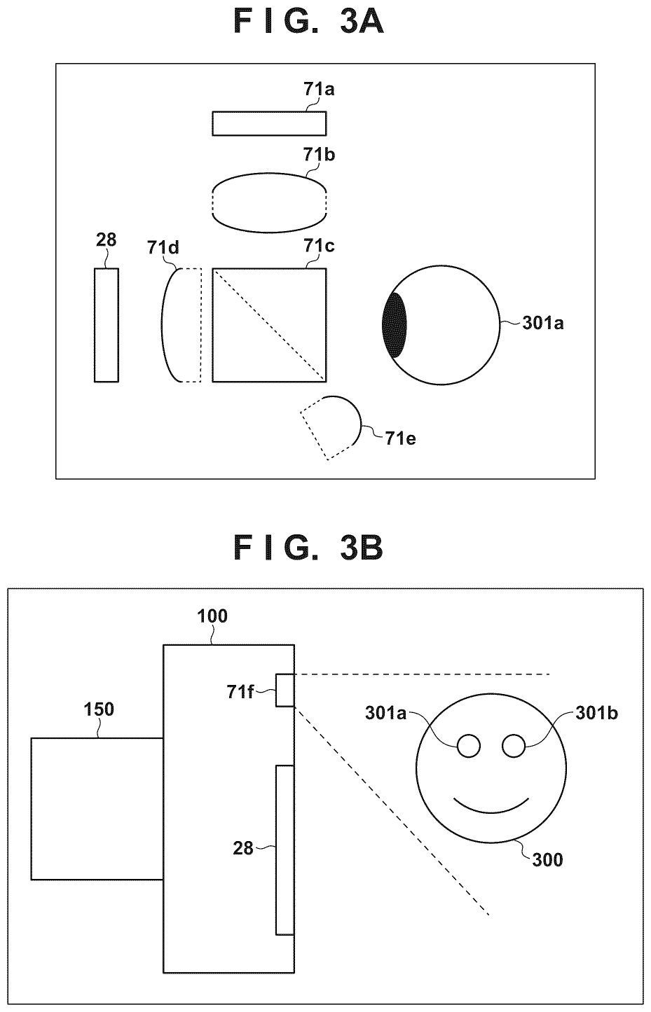

FIG. 3A is a side view showing a schematic configuration example of the gaze detection unit 71 provided in the viewfinder. The gaze detection unit 71 detects the rotation angle of the optical axis of the eyeball 301a of the user who is looking at the display unit 28 provided inside the main body 100 through the eyepiece of the viewfinder as the direction of the line of sight. Based on the detected direction of the line of sight, the position at which the user is gazing at the display unit 28 (the gaze point in the displayed image) can be identified.

For example, a live view image is displayed on the display unit 28, and the user can observe the contents displayed on the display unit 28 through an eyepiece lens 71d and a dichroic mirror 71c by looking into the eyepiece window. A light source 71e can emit infrared light in the direction of the eyepiece window (toward the outside of the main body 100). When the user is looking through the viewfinder, the infrared light emitted by the light source 71e is reflected by the eyeball 301a and returns to the inside of the viewfinder. The infrared light that enters the viewfinder is reflected by the dichroic mirror 71c in the direction of a light receiving lens 71b.

The light receiving lens 71b forms an eyeball image by infrared light on the imaging surface of an image sensor 71a. The image sensor 71a is a two-dimensional image sensor having a filter that passes infrared light. The number of pixels of the image sensor 71a for detecting the line of sight may be less than the number of pixels of the image sensor 22 for shooting. The eyeball image captured by the image sensor 71a is transmitted to the system control unit 50. The system control unit 50 detects the position of the corneal reflection of infrared light and the position of the pupil from the eyeball image, and detects the line of sight direction from the positional relationship between the two. In addition, the system control unit 50 detects the position of the display unit 28 where the user is gazing (the gaze point in the displayed image) based on the detected line of sight direction. Note that the image processing unit 24 may detect the position of the corneal reflection and the position of the pupil from the eyeball image, and the system control unit 50 may acquire these positions from the image processing unit 24.

The present invention does not depend on the method of gaze detection or the configuration of the gaze detection unit. Therefore, the configuration of the gaze detection unit 71 is not limited to that shown in FIG. 3A. For example, as shown in FIG. 3B, the gaze may be detected based on a captured image obtained by a camera 71f arranged near the display unit 28 provided on the back of the main body 100. The angle of view of the camera 71f shown by the dotted line is set so that the face 300 of the user who takes images while looking at the display unit 28 is captured. The gaze direction can be detected based on the images of the eye regions 301a and 301b detected from the image captured by the camera 71f. In a case where an infrared light image is used, a light source 71e is placed near the camera 71f, and infrared light is projected onto a subject within the angle of view to capture the image. The method of detecting the gaze direction from the obtained image may be the same as that used for the configuration of FIG. 3A. Also, when a visible light image is used, light does not need to be projected. In a case where a visible light image is used, the gaze direction can be detected from the positional relationship between the inner corner of the eye and the iris of the eye region.

Return to FIG. 1 again, a power supply control unit 80 is composed of a battery detection circuit, a DC-DC converter, a switch circuit for switching between blocks to be energized, etc., and detects whether a battery is attached, the type of battery, and the remaining battery power. The power supply control unit 80 also controls the DC-DC converter based on the detection results and instructions from the system control unit 50, and supplies the necessary voltage to each unit, including a recording medium 200, for the necessary period A power supply unit 30 is composed of a battery, an AC adapter, etc.

An I/F 18 is an interface with a recording medium 200 such as a memory card or a hard disk. Data files such as captured images and audio are recorded on the recording medium 200. The data files recorded on the recording medium 200 can be read out via the I/F 18 and played back via the image processing unit 24 and the system control unit 50.

A communication unit 54 realizes communication with an external device by at least one of wireless communication and wired communication. Images captured by the image sensor 22 (including a live view image) and images recorded in the recording medium 200 can be transmitted to an external device via the communication unit 54. In addition, image data and various other information can be received from an external device via the communication unit 54.

A posture detection unit 55 detects the posture of the main body 100 with respect to the direction of gravity. The posture detection unit 55 may be an acceleration sensor or an angular velocity sensor. The system control unit 50 can record orientation information corresponding to the posture detected by the posture detection unit 55 during shooting in a data file that stores image data obtained by the shooting. The orientation information can be used, for example, to display a recorded image in the same orientation as when the image was shot.

In the digital camera system having the above configuration, the image processing unit 24 detects areas of an image captured by the image sensor 22 that are determined to match predetermined characteristics using a known method as feature regions, and outputs detection information such as the position, size, and reliability of each feature region to the system control unit 50.

The system control unit 50 that has acquired the detection information selects, as the main subject region, the feature region that is most suitable as the main subject in the shooting scene from among the feature regions. For example, when a plurality of feature regions are detected in shooting a specific sports competition, the system control unit 50 selects, as the main subject region, the region of the subject that is determined to be performing an action that is important in shooting the event by action determination processing from among the subjects corresponding to the feature regions.

The system control unit 50 then performs various types of shooting control so that the main subject region becomes appropriate in an image. Such controls include the following controls. First, automatic focus adjustment (AF) for focusing on the main subject region, automatic exposure control (AE) for properly exposing the main subject region, automatic white balance control for properly adjusting the white balance of the main subject region, and automatic flash light amount adjustment for properly adjusting the brightness of the main subject region are included. However, the controls are not limited to these. Furthermore, the system control unit 50 displays a rectangular frame corresponding to the main subject region on the shooting screen displayed on the display unit 28.

The present invention does not depend on the type or detection method of a feature region, and a known method can be used to detect a feature region, so a description of the detection method of the feature region will be omitted. A feature region can also be used to detect subject information. In a case where a feature region is a face region, subject information includes, but is not limited to, whether or not red-eye occurs, whether or not the eyes are closed, facial expression (e.g., smiling), and the like.

Next, with reference to the flowchart in FIG. 5, a processing procedure for performing a shooting preparation operation and a continuous shooting operation while repeatedly performing focus adjustment and exposure control in the digital camera system having the above configuration will be described.

FIG. 5 is a flowchart illustrating the procedure of the shooting preparation operation and the continuous shooting operation after SW1 is turned ON. The processes from steps S501 to S506 are a series of processes corresponding to one frame in the continuous shooting, and the continuous shooting is performed by repeating this series of processes.

In step S501, the system control unit 50 controls to generate a live view image signal by accumulating charges in the image sensor 22, and outputs the generated image signal to the image processing unit 24 via the A/D converter 23. The image processing unit 24 generates a captured image, image signals for phase difference AF, and an image signal for AE based on the input image signal, and stores them in the memory 32 via the memory control unit 15. These data stored in the memory 32 are read out and used as appropriate in each of the subsequent steps.

In step S502, the image processing unit 24 performs feature region detection processing on the captured image generated in step S501, and simultaneously executes action determination processing on each detected feature region. Next, the image processing unit 24 outputs the number of detected feature region/regions, information on each feature region, action determination results, and the like, to the system control unit 50. Subsequently, the system control unit 50 sets a main subject region in the captured image based on the acquired feature region/regions and action determination result information. Details of the feature region detection processing, action determination processing, and main subject region setting processing performed in step S502 will be described later.

In step S503, the system control unit 50 performs focus detection based on the image signals for phase difference AF corresponding to the main subject region set in step S502, and performs AF processing to focus on the subject within the main subject region by actuating the lens group 103 based on the detected defocus amount. The system control unit 50 also performs automatic exposure calculations using a known method based on the image signal for AE obtained from the pixels of the main subject region, and determines the aperture value (AV value), shutter speed (TV value), and ISO sensitivity (ISO value) using an exposure program chart stored in advance.

Note that if a main subject region is not set in step S502, the focus position and exposure values of the immediately preceding frame are retained.

In step S504, the system control unit 50 detects the state of SW2, and if SW2 is ON, the process proceeds to step S505, and if SW2 is OFF, the process proceeds to step S506.

In step S505, the system control unit 50 adjusts the opening amount of the aperture 102 based on the aperture value determined in step S503, and then actuates the shutter 101 based on the shutter speed also determined in step S503 to expose the image sensor 22 and generate a still image signal. The generated still image signal is subjected to a gain amplification according to the ISO sensitivity and then transmitted to the image processing unit 24, which generates a still image based on the received still image signal and outputs it to the system control unit 50. The system control unit 50 then stores the received still image in the recording medium 200 and displays the still image on the display unit 28.

In step S506, the system control unit 50 detects the states of SW1 and SW2, and if either SW1 or SW2 is ON, the process proceeds to step S501, and if both are OFF, the shooting preparation operation and the continuous shooting operation are stopped.

The above is the procedure of the shooting preparation operation and the continuous shooting operation in this embodiment. Note that during the continuous shooting operation, shooting of the live view image in step S501 may not be performed, and the processes of steps S502 and S503 may be performed using the still image of the previous frame. Alternatively, the processes of steps S501 to S503 may be repeated a plurality of times between still image shootings during the continuous shooting operation.

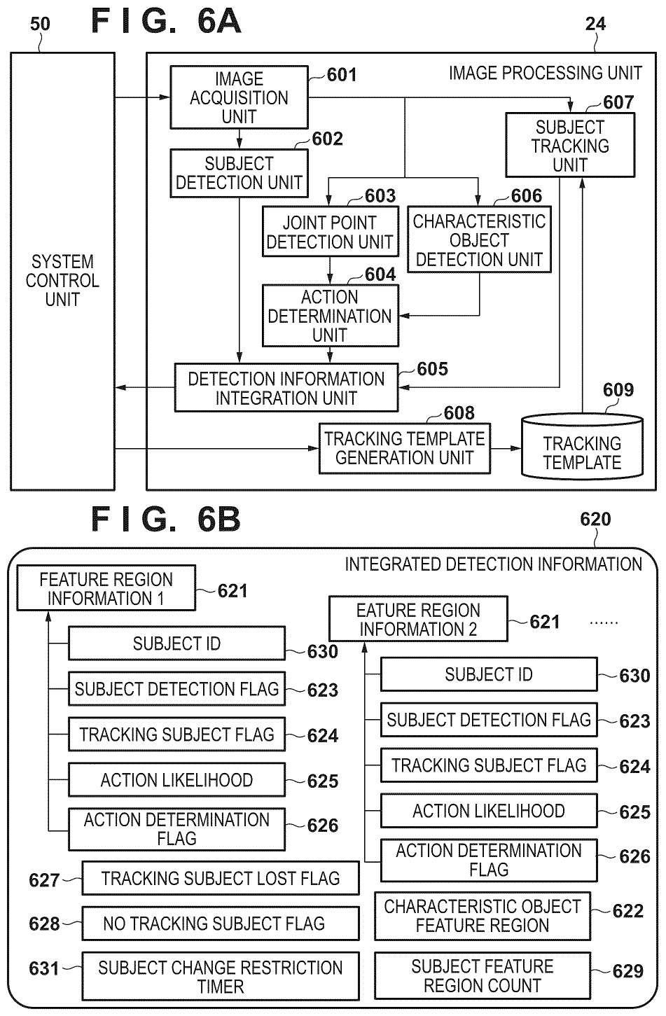

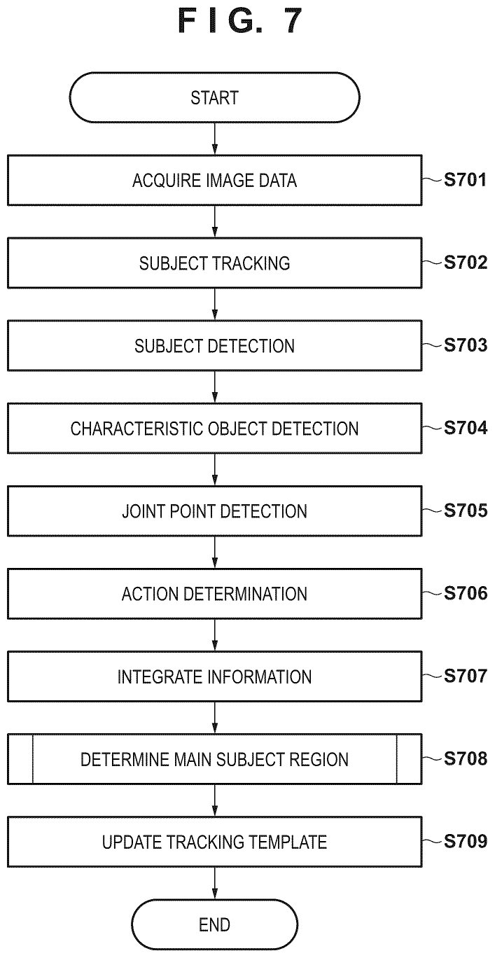

Next, the processing of setting the main subject region performed in step S502 will be described in detail. FIG. 6A is a functional block diagram of the image processing unit 24, and FIG. 7 is a flowchart showing the procedure of the feature region detection and main subject selection processing. Note that in the following description, a ball game played by a plurality of people will be described as an example of a target scene, but scenes to which this embodiment can be applied are not limited to this.

First, in step S701, the system control unit 50 reads out the captured image generated in step S501 or S505 of the previous frame, and outputs an image signal of the read captured image to an image acquisition unit 601. The image acquisition unit 601 outputs the acquired image signal to a subject detection unit 602, a joint point detection unit 603, a characteristic object detection unit 606, and a subject tracking unit 607.

In step S702, the subject tracking unit 607 reads out a tracking template 609 and performs subject tracking processing on the captured image acquired in step S701. The subject tracking processing is to detect an area having features highly consistent with the tracking template in an image as a feature region. Since the tracking template 609 includes feature information of the feature region corresponding to the main subject in the immediately preceding frame, the subject tracking processing can detect the position and size of the main subject detected in the immediately preceding frame in the current frame. Note that any method may be used for the subject tracking processing, and a known method is used here.

After the subject tracking processing, the subject tracking unit 607 outputs the position, size, and tracking reliability of the detected feature region to a detection information integration unit 605. If no feature information is detected in the current frame by the subject tracking processing, a tracking subject lost flag indicating that the tracked subject has been lost is set, and output the flag to the detection information integration unit 605. Further, if feature information is not set in the tracking template 609, the subject tracking processing is not executed, and the subject tracking unit 607 sets a no tracking subject flag and outputs the flag to the detection information integration unit 605.

In step S703, the subject detection unit 602 performs subject detection processing on the captured image acquired in step S701. The subject detection processing is processing to detect a specific subject/subjects in an image as a feature region. Here, the targets to be detected are people and each part of a person, such as the eyes, face, head, upper body, and torso. Therefore, the subject detection processing can detect the position and size of each person in an image. Any method can be used for the subject detection processing, and a known method is used here.

After the subject detection processing, the subject detection unit 602 outputs the position, size, and detection reliability of each detected feature region to the detection information integration unit 605.

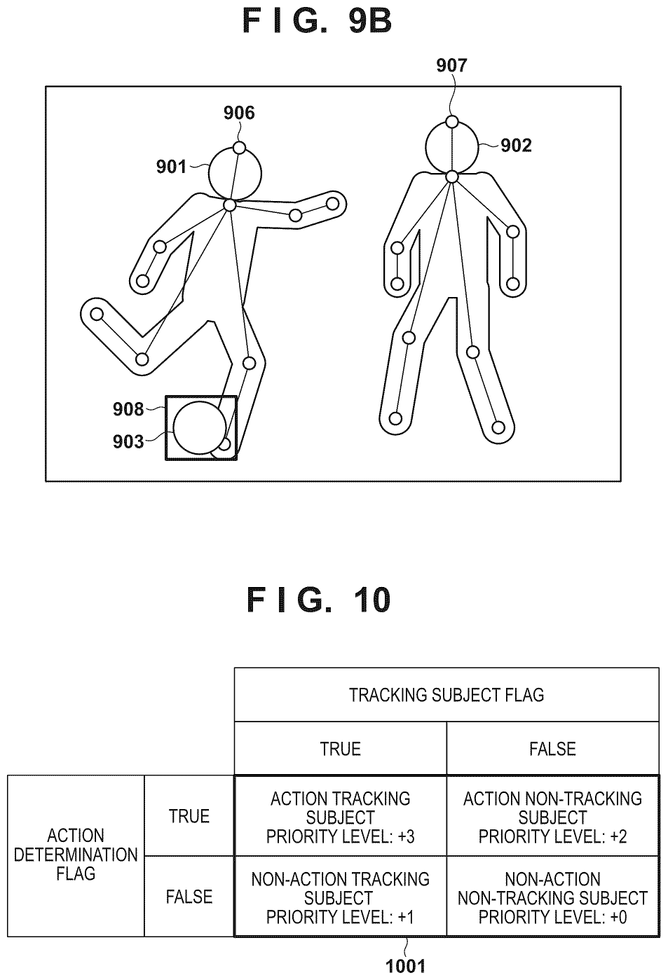

FIG. 9A is a diagram illustrating a state in which the head of a subject 901 is detected as a feature region 904 and the head of a subject 902 is detected as a feature region 905.

In step S704, the characteristic object detection unit 606 performs characteristic object detection processing on the captured image acquired in step S701. The characteristic object detection processing is processing for detecting an object characteristic to a scene from an image as a feature region. In this case, a ball in a scene of a ball game is used as an example of an object characteristic to the scene. Therefore, the position and size of the ball in the image are detected by the characteristic object detection processing. Any method may be used for the characteristic object detection processing, and a known method is used here.

After the characteristic object detection processing, the characteristic object detection unit 606 outputs the position and size of each detected feature region to an action determination unit 604.

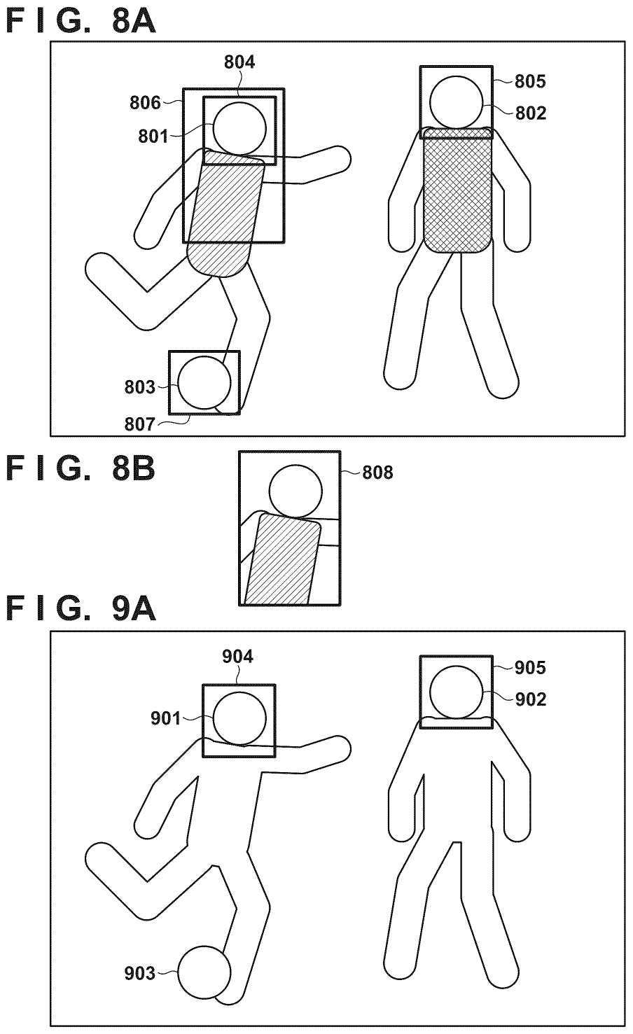

FIG. 8A is a diagram showing an example of the results of executing the detection processes performed in steps S702 to S704 in a case of shooting a soccer game.

The subject detection unit 602 detects the heads of subjects 801 and 802, and subject feature regions 804 and 805 are set based on the detected heads. The characteristic object detection unit 606 detects a ball 803, and a characteristic object region 807 is set based on the detected ball 803. The subject tracking unit 607 performs tracking using template image data 808 shown in FIG. 8B, which corresponds to the tracking template 609, and the result is a tracking feature region 806. Based on the physical features and the shape and pattern of clothing contained in the template image data 808, the subject 801 with a higher degree of matching in features is detected.

In the example shown in FIG. 8A, the feature region of the subject is the head, but it is not limited to this and may be any other part that can be determined as the subject, such as the face, eyes, entire body, upper body, lower body, or torso.

In step S705, the joint point detection unit 603 executes joint point detection processing on the captured image acquired in step S701. The joint point detection processing is processing of detecting the positions of joint points (predetermined parts) of all subjects in the image and connecting the joint points. Here, the joint points to be detected are a total of 10 points: the top of the person's head, neck, both elbows, both wrists, both knees, and both ankles.

After detecting the joint points, the joint point detection unit 603 connects joint points that are estimated to be joint points of the same person together. A collection of 1 to 10 joint points that are connected to each other becomes the joint point information of one subject.

Note that any method may be used for detecting and connecting joint points, and a known method is used here.

After the joint point detection processing, the joint point detection unit 603 outputs the position information and connection information of each joint point to the action determination unit 604.

In step S706, the action determination unit 604 executes action determination processing using the position information and connection information of the joint points detected by the joint point detection unit 603 and the position and size of the characteristic object detected by the characteristic object detection unit 606. The action determination processing is processing for determining whether or not each detected subject is in a state where an action important for shooting is being performed in a sports competition to be shot. An action important for shooting is a specific action that is often given priority in shooting various sports competitions, such as shooting, passing, dribbling, etc. in soccer and basketball, and receiving, tossing, spiking, etc. in volleyball. In addition, an action important for shooting also includes defensive actions such as a goalkeeper's saving and sliding in soccer. Hereinafter, a state in which the subject is performing an action important for shooting (a predetermined motion state) is referred to as an “action state”. The action important for shooting is associated with various sports competitions in advance, and a model obtained by machine-learning the position information of the joint points and the position and size of the characteristic object corresponding to the action state is stored in the non-volatile memory 56 or memory 32, etc. in advance. Then, by selecting a sports competition by using the operation unit 70 at any time before the start of shooting, a model required for action determination processing can be used. Alternatively, position information of joint points and position and size information of a characteristic object corresponding to action states may be stored in the non-volatile memory 56 or memory 32, etc., and the position information of joint points and position and size information of the characteristic object required for action determination processing may be used.

In the action determination processing, an action likelihood is calculated as an index for determining whether the subject is in an action state. The action likelihood indicates the likelihood that the subject is in an action state, and is calculated as a numerical value between 0.000 and 1.000 based on the position of each joint point of each subject and the position and size of the characteristic object. Then, a subject whose action likelihood is equal to or greater than a predetermined threshold value is determined to be in an action state. The numerical range of the action likelihood may be set arbitrarily.

After the action determination processing, the action determination unit 604 outputs the position information of each joint, the action likelihood, the action determination result, and feature region information (position, size) of the characteristic object to the detection information integration unit 605.

FIGS. 9A and 9B are diagrams showing an example of the action determination processing for a subject 901 about to shoot and a subject 902 in a defensive stance in image capture of a soccer game.

The subject 901 is in an action state because he/she is preparing to kick a ball 903. On the other hand, the subject 902 is away from the ball 903 and is therefore not in an action state.

FIG. 9B is a diagram showing a state in which a total of ten positions of the top of the head, neck, elbows, wrists, knees, and ankles of the subject 901 are detected as joint points 906, and joint points 907 of the subject 902 are similarly detected. Moreover, a region 908 is a feature region in a case where the ball 903 is detected by the characteristic object detection unit 606.

In the action determination, the action likelihood of the subject 901 is calculated to be high because the positions of the joint points 906 corresponding to the subject 901 indicate a posture of kicking a ball, and a feature region 908 of the ball 903 is detected near the ankle of the joint point 906. On the other hand, the action likelihood of the subject 902 is calculated to be low because the joint points 907 indicate a posture close to being upright, and the distances between the joint points 907 and the feature region 908 of the ball 903 is large. As a result, the subject 901 corresponding to the joint points 906 is determined to be in an action state, and the object 902 corresponding to the joint points 907 is determined to be not in an action state.

Any method may be used to calculate the action likelihood. For example, a method using a neural network, which is a machine learning method, may be used to learn the joint points and the ball position in the correct action state as training data. A specific example of this method is the method described in Japanese Patent Laid-Open No. 2021-071794. Another machine learning method such as a support vector machine or a decision tree may be used, or, not being limited to machine learning, a function that outputs a reliability or a probability value based on a certain model may be constructed. In this embodiment, the case where the likelihood is used as the likelihood that the subject is performing an important action in shooting will be described, but a value other than the likelihood may be used. For example, the reciprocal of the distance between the center of gravity of the subject and the center of gravity of the characteristic object may be used as the reliability.

Furthermore, if an arbitrary subject is determined to be in an action state continuously or intermittently over a plurality of frames, a correction such as increasing the action likelihood of the subject may be applied. The reason for applying such a correction is that when a specific subject continues to be determined to be in an action state, it can be inferred that the user is framing the subject, and that the subject is more likely than other subjects to continue to be in an action state in the future.

In this embodiment, the main subject is determined using information on the characteristic object as well, but it is also possible to determine the main subject using only the joint point information of the subject/subjects. In addition, data obtained by applying a predetermined transformation such as a linear transformation to the joint positions and the position and size of the characteristic object may be used as input data.

In step S707, the detection information integration unit 605 integrates information acquired from the subject detection unit 602, the action determination unit 604, and the subject tracking unit 607 to generate integrated detection information 620. FIG. 6B shows an example of the integrated detection information 620. The integrated detection information 620 includes feature region information 621 in the same number as the number of subjects detected by the subject detection unit 602, a subject feature region count 629 indicating the number of the subjects, and a characteristic object feature region 622 detected by the characteristic object detection unit 606.

The detection information integration unit 605 associates a feature region/regions with action determination result/results that are estimated to correspond to the same subject/subjects based on the feature region/regions of the subject/subjects detected by the subject detection unit 602 and the action determination result/results determined by the action determination unit 604. The association is performed by, for example, comparing each pair of joint points of the top of the head and the neck that are in a connected relationship with the head region or the upper body region of each detected subject, and associating a pair of joint points that are in a positional relationship closer than a predetermined value with the feature region of the subject. In FIGS. 9A and 9B, the feature region 904 and the joint points 906, and the feature region 905 and the joint points 907 are respectively associated as data corresponding to the same subjects. Then, the associated data is stored in the feature region information 621. The feature region information 621 includes a subject detection flag 623 indicating that the feature region is detected by the subject detection unit 602, an action likelihood 625 for each subject, and an action determination flag 626 indicating whether the subject is in an action state.

The feature region information 621 also includes a tracking subject flag 624 indicating that the target subject is a tracking subject. The detection information integration unit 605 compares the positions and sizes of the tracking feature region acquired from the subject tracking unit 607 and in the feature region information 621 of each subject, and if it is determined that there is an overlap of a predetermined ratio or more, sets the tracking subject flag 624 included in the data of the corresponding feature region information 621 to TRUE. Note that if none of the feature region information 621 satisfies the overlap condition for the tracking feature region, one new independent feature region information 621 is added, and only the tracking subject flag 624 is set to TRUE, and the subject feature region count 629 is added by 1.

Furthermore, the integrated detection information 620 includes a tracking subject lost flag 627 and a no tracking subject flag 628 set in the subject tracking unit 607, and a subject ID 630 for identifying each feature region. The subject ID 630 is set such that the same ID is assigned to subjects that are estimated to be the same subject, for each subject detected from images of different frames.

The integrated detection information 620 also includes a subject change restriction timer 631. Each time a main subject region is determined in step S708, which will be described later, if the action determination flag 626 in the feature region information 621 corresponding to the main subject region is TRUE, a predetermined value is set in the subject change restriction timer 631. If the value is greater than 0, the subject change restriction timer 631 counts down in accordance with the passage of time, and stops counting down when the value becomes 0. The subject change restriction timer 631 is used to restrict a change of the main subject in step S708.

The subject change restriction timer 631 may be a numerical value representing the number of frames, or may be set as real time.

Once integration of all the detected information is complete, the detection information integration unit 605 outputs the integrated detection information 620 to the system control unit 50.

In step S708, the system control unit 50 determines a main subject region from the feature region information 621 based on the acquired integrated detection information 620. The method of determining the main subject region will be described later in detail.

In step S709, a tracking template generation unit 608 acquires information on the main subject region determined by the system control unit 50, and updates the information of the tracking template 609 based on the acquired information on the main subject region. The updated tracking template 609 is used by the subject tracking unit 607 to detect the feature region of the main subject in the next frame.

The above is the procedure for the main subject region setting processing in this embodiment.

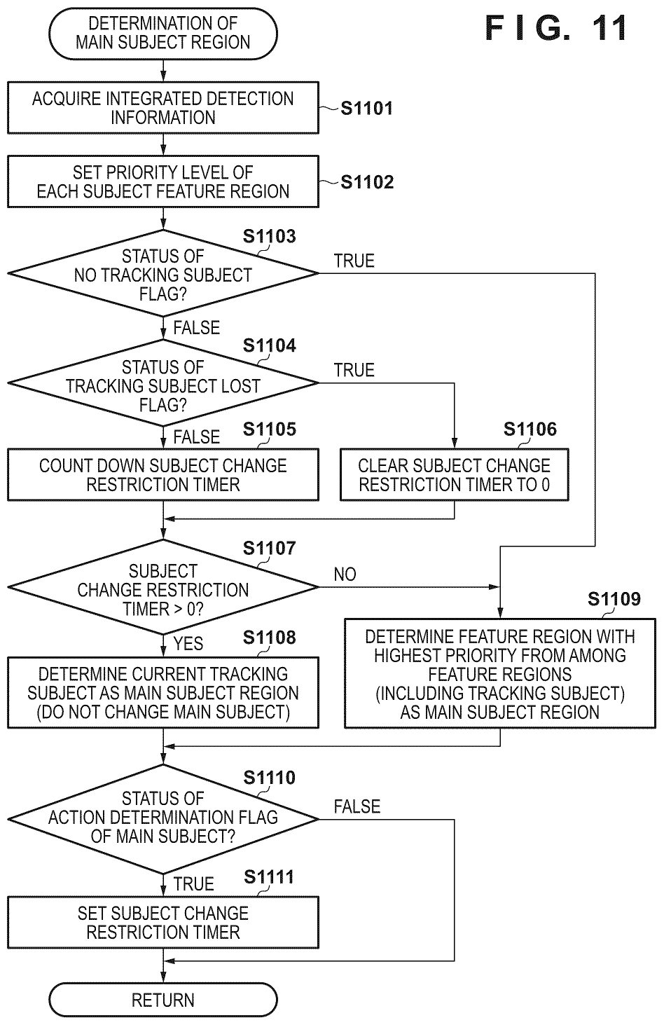

Next, a detailed procedure performed in step S708 by the system control unit 50 to determine the main subject region will be described with reference to the flowchart of FIG. 11.

First, in step S1101, the system control unit 50 acquires the integrated detection information 620 from the detection information integration unit 605.

In step S1102, the system control unit 50 classifies each subject feature region included in the acquired integrated detection information 620 into four categories 1001 as shown in the table of FIG. 10 based on the corresponding tracking subject flag 624 and action determination flag 626. That is, the feature region is classified as follows:
A feature region that is in an action state and is a tracking subject→an action tracking subject
A feature region that is in an action state and is not a tracking subject→an action non-tracking subject
A feature region that is not in an action state and is a tracking subject→a non-action tracking subject
A feature region that is not in an action state and is not a tracking subject→a non-action non-tracking subject

Then, the priority level for determining the main subject for an action tracking subject is set to +3, for a non-action tracking subject the priority level is set to +2, for a non-action tracking subject the priority level is set to +1, and for a non-action non-tracking subject the priority level is set to 0. The higher the number of the priority level, the higher the priority.

In step S1103, the system control unit 50 checks the no tracking subject flag 628, and if it is TRUE, the process proceeds to step S1109, and if it is FALSE, the process proceeds to step S1104.

In step S1104, the system control unit 50 determines whether the tracking subject lost flag 627 is FALSE, i.e., whether the tracking main subject was detected in the previous image. If the tracking subject lost flag 627 is FALSE (tracking subject was detected), the process proceeds to step S1105, and if the tracking subject lost flag 627 is TRUE (tracking subject was not detected), the process proceeds to step S1106.

Note that the process may proceed to step S1106 if the tracking subject lost flag 627 remains TRUE for a predetermined number of frames.

In step S1105, the system control unit 50 counts down the subject change restriction timer 631 in accordance with the time elapsed since the immediately previous frame. Note that the subject change restriction timer 631 was set to a predetermined value in step S1111, which will be described later, in the past frame.

In step S1106, the system control unit 50 determines that the tracking subject has gone out of frame, and clears the subject change restriction timer 631 to zero.

In step S1107, if the subject change restriction timer 631 is greater than 0, the system control unit 50 determines that the timer has not expired and the process proceeds to step S1108, and if the subject change restriction timer 631 is 0, the system control unit 50 determines that the timer has expired and the process proceeds to step S1109.

In step S1108, the system control unit 50 determines, as the main subject region, a feature region with the tracking subject flag 624 being TRUE, based on the feature region information 621. Here, since the subject change restriction timer 631 has not expired in step S1107, it is determined that the main subject is not to be changed, and the tracking subject from the previous frame is to be maintained as the main subject.

In step S1109, the system control unit 50 determines the feature region with the highest priority set in step S1102 as the main subject region based on the feature region information 621. If a plurality of feature regions have the same priority and are of subjects in an action state, the feature region with the highest action likelihood 625 is determined as the main subject region. Further, if the feature regions have the same priority and are of subjects in a non-action state, the feature region that is located closer to the center of the image and has the largest area is determined as the main subject region based on the positions and sizes of the feature regions. Note that in a case of selecting a main subject region from subjects in an action state, the selection may be based on the positions and sizes of the feature regions. However, in either case, if the subject feature region count 629 is 0, the main subject region is not determined, the process ends and returns to step S708 in FIG. 7.

In addition, since all the feature region information 621 is targeted in the selection of the main subject region, in a case where a tracking subject is selected from that, it is determined that the tracking subject from the previous frame is maintained as the main subject. Therefore, the main subject is not necessarily changed in the process of step S1109.

In step S1110, if the action determination flag 626 of the feature region information 621 determined as the main subject region in step S1108 or S1109 is TRUE, it is determined that the main subject is in an action state, and the process proceeds to step S1111.

If FALSE, the process returns to step S708 in FIG. 7.

Next, in step S1111, the system control unit 50 sets the subject change restriction timer 631 to a predetermined value. That is, if a subject in an action state is set as the main subject region, or if a subject being tracked from a previous frame is in an action state in the current frame, the subject change restriction timer 631 is set. This restricts changing the main subject to another subject until the subject change restriction timer reaches 0. When the processing of step S1111 is completed, the process returns to step S708 in FIG. 7.

The period of time set in the subject change restriction timer 631 may be longer in the order of low, standard, and high sensitivity based on the sensitivity setting in FIG. 4.

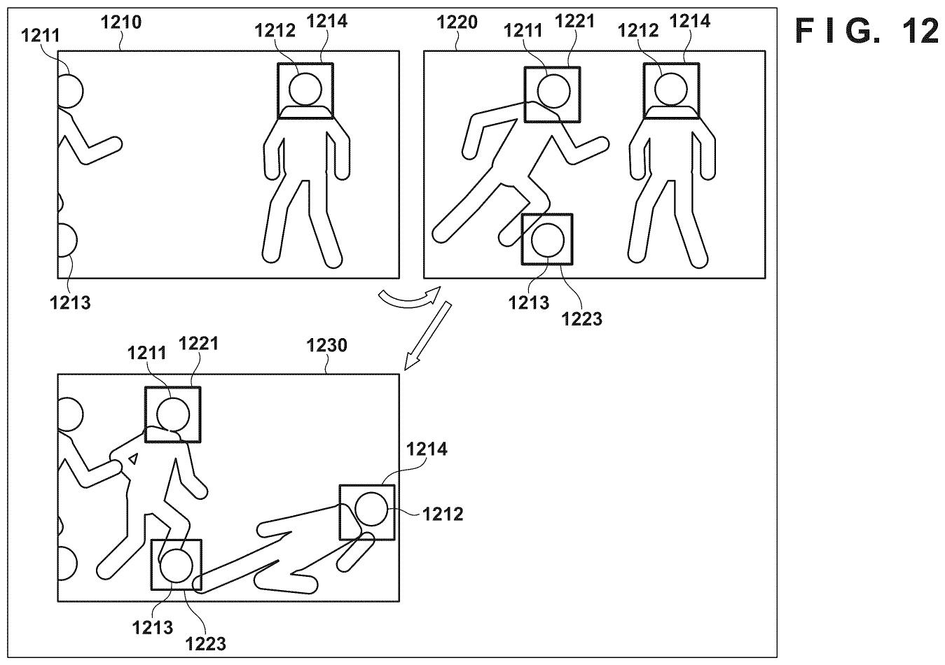

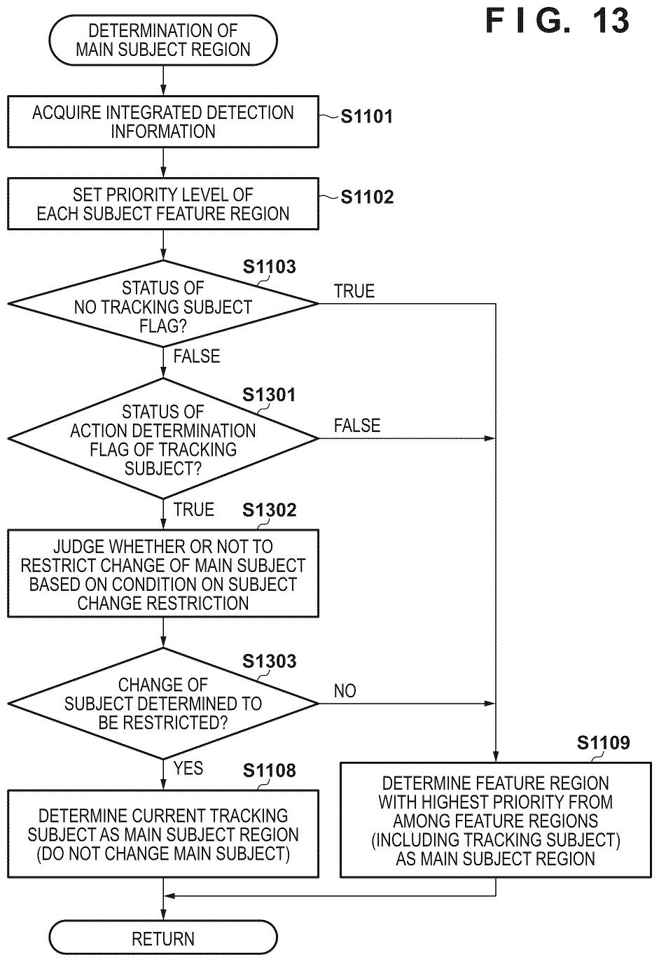

FIG. 12 is a diagram showing a specific example of the process of determining the main subject region shown in FIG. 11 in a soccer shooting scene.

In a scene 1210, a subject feature region 1214 of a subject 1212 is detected, and a subject 1211, which is dribbling into the angle of view, and a ball 1213, which is a characteristic object, are not detected. Also, the subject 1212 is a subject selected as the main subject region in the frame immediately before the scene 1210, but is simply standing and is not in an action state (priority level=1). In this scene 1210, the subject feature region 1214, which is the only subject feature region, is set as the main subject region (step S1109), but is not in an action state, so the subject change restriction timer 631 is not set (FALSE in step S1110).

Subsequently, when time passes and the scene changes to a scene 1220, the dribbling subject 1211 and the ball 1213 enter the shooting screen, and a subject feature region 1221 of the subject 1211 and a characteristic object region 1223 of the ball 1213 are detected. Here, the subject 1211 is in a dribbling posture and is keeping the ball 1213, so the subject feature region 1221 is determined to be in an action state (priority level=2). On the other hand, the subject feature region 1214 of the subject 1212 continues to be detected (FALSE in step S1103), but is not in an action state (priority level=1). Therefore, in this scene 1220, the main subject region is changed from the subject feature region 1214 to the subject feature region 1221 based on the priority level (step S1109). At the same time, the subject change restriction timer 631 is set to a predetermined value in step S1111.

Subsequently, when time passes and the scene changes to a scene 1230, the subject 1212 is in a sliding position to steal the ball 1213, and the subject feature region 1214 is determined to be in an action state (priority level=2). On the other hand, the subject 1211 stops dribbling to keep the ball 1213, and therefore the subject feature region 1221 is less likely to be determined to be in an action state, but is still detected as a tracking subject (priority level=1). However, at the time of the scene 1230, the subject change restriction timer 631 set in the scene 1220 has not yet expired (YES in step S1107), so the subject feature region 1221 continues to be selected as the main subject region (step S1108), and the main subject is not changed to the subject feature region 1214.

The above is a detailed explanation of the procedure for determining the main subject region. With this configuration, once a subject in an action state is determined as the main subject, even if another subject in an action state is detected in a subsequent frame, the main subject will not be changed while the subject change restriction timer is running. Therefore, in a shooting scene in which a plurality of subjects are in action state at the same time, it is possible to prevent frequent changes in the main subject region between the plurality of subjects.

On the other hand, by not allowing the subject change restriction timer to function when changing from a subject in a non-action state to a subject in an action state, highly responsive subject changes using action judgment are possible when shooting sports competitions where scenes change at high frequency. Furthermore, by clearing the subject change limit timer to zero when the tracking subject is lost, it is possible to quickly change subjects when the tracking subject is caused to exit the frame and another subject in an action state is caused to enter the frame.

Note that these methods of setting priority levels and determining the main subject region are just examples, and any method that achieves the following two operations may be used.
(1) The main subject is changed immediately from a subject that is not in an action state to a subject that is in an action state.
(2) Changing from a main subject in an action state to another subject in an action state is performed only if predetermined conditions are satisfied.

Furthermore, even if a main subject that is in an action state is no longer in the action state, the rule that the main subject can be changed only if the predetermined conditions are satisfied may be maintained until a predetermined time has elapsed.

### Second Embodiment

Next, a second embodiment of the present invention will be described. In the second embodiment, another specific example of the means for realizing the two operations described above will be described.

In this embodiment, a method for restricting the change of the main subject from a subject in an action state to another subject in an action state using a means different from that of the first embodiment will be described.

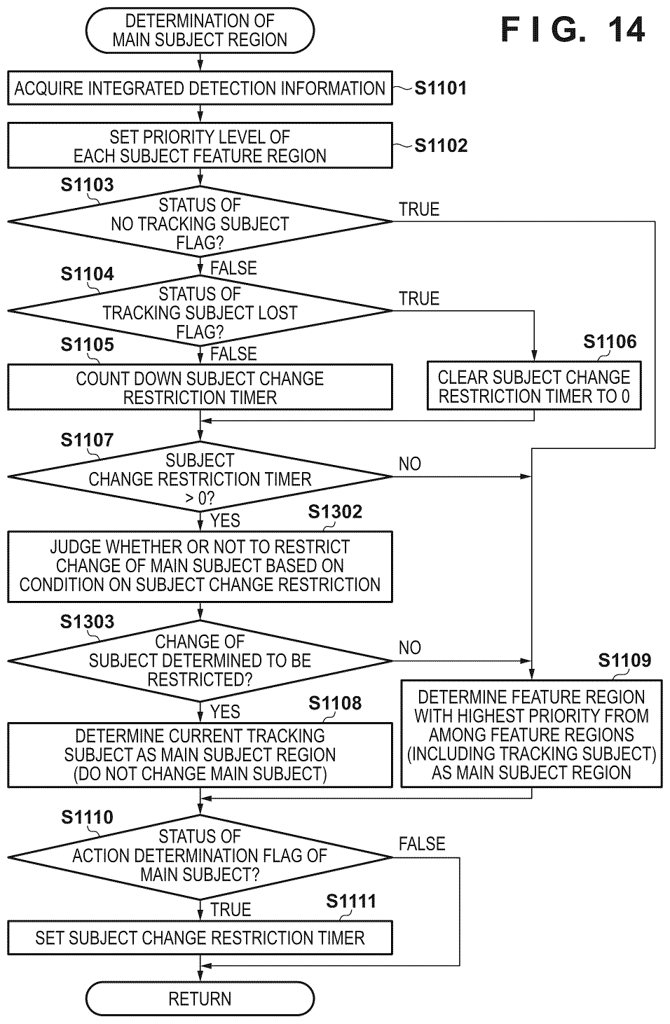

The difference between this embodiment and the first embodiment is that subject change restriction determination is performed by a method other than the method using the subject change restriction timer 631, and the other configurations are the same. Therefore, a method of restricting a change of the main subject in this embodiment will be described with reference to FIG. 13.

FIG. 13 is a flowchart showing a detailed procedure of the system control unit 50 to determine the main subject region in this embodiment. Note that the same step numbers are used for steps that perform the same processes as those in FIG. 11 described in the first embodiment, and descriptions thereof will be omitted.

In step S1301, the system control unit 50 refers to the action determination flag 626 of the feature region information 621 corresponding to the tracking subject, and if it is TRUE, the process proceeds to step S1302, and if it is FALSE, the process proceeds to step S1109. The determination made here is to restrict the change of the main subject in a case where the tracking subject is in an action state.

In step S1302, the system control unit 50 judges whether or not to restrict the change of the main subject based on the information in the integrated detection information 620 and predetermined conditions for restricting the change of the main subject. The result of this judgment is used in the determination in step S1303. The specific method of the judgment will be described later.

In step S1303, if the system control unit 50 determines to restrict the change of the main subject based on the judgment result in step S1302, the process proceeds to step S1108, and if the system control unit determines not to restrict the change of the main subject, the process proceeds to step S1109.

Below, several methods are given and specifically explained for determining whether or not to restrict the change of the main subject in step S1302.

Note that the methods given below may be implemented in addition to the main subject change restriction determination by using the subject change restriction timer 631 in steps S1104 to S1111 in FIG. 11 of the first embodiment, or may partially or completely replace it. In the following explanation, the characteristic object may be represented as a ball and the subject area as a person. The flowchart in FIG. 13 illustrates a case in which the main subject change restriction determination using the subject change restriction timer 631 is completely replaced.

The following restriction conditions 1 to 13 indicate specific conditions for restricting the change of the main subject for determining whether or not to restrict the change of the subject in step S1302. Note that the restriction conditions 1 to 13 include conditions for determining that the change of the main subject is restricted if the condition is met, and conditions for determining that the change of the main subject is not restricted if the condition is met.

Restriction condition 1: When a plurality of subject feature regions in an action state are detected near (within a predetermined distance range of) a characteristic object feature region and the tracking subject region is one of those subject feature regions, it is determined that the change of the main subject is to be restricted. This is because, in a sports competition where a plurality of people gather near the ball, if the main subject is changed each time, the main subject changes may occur frequently.

Restriction condition 2: In a given series of frames, if the characteristic object feature region moves away from the tracking subject region and approaches another subject region, and the other subject is in an action state, it is determined that the change of the main subject is not to be restricted, and otherwise it is determined that the change of the main subject is to be restricted. This is to smoothly change the main subject in accordance with the movement of the ball when the ball is passed from one person to another.

Restriction condition 3: When a subject region in an action state is detected separately from the tracking subject, and the distance between that subject region and the characteristic object region is closer than the distance between any other subject region and the characteristic object region by a predetermined distance or more, it is determined the change of the main subject is not to be restricted, and otherwise it is determined that the change of the main subject is to be restricted. This allows the subject keeping the ball to be stably selected as the main subject in accordance with the passing of the ball between subjects.

Restriction condition 4: When a subject region in an action state is detected separately from the tracking subject, and the distance between the subject region and the characteristic object region is greater than the distance between the tracking subject and the characteristic object region by a predetermined amount, it is determined that the change of the main subject is to be restricted. This makes it possible to restrict the change of the main subject from a subject located near the ball to a subject located far from the ball, and to stably continue to select the subject keeping the ball as the main subject in accordance with the movement of the ball.

Restriction condition 5: When the user places a subject in an action state other than the tracking subject at the center of a predetermined area at a timing close to the timing of the detection of the other subject, the change of the main subject is determined not to be restricted, and otherwise determined to be restricted. Here, the predetermined area is, for example, the shooting screen or the focus detection area. This allows smooth change of the main subject when the subject to be shot becomes an action state and the user instantaneously frames the subject.

Restriction condition 6: Using the gaze position information of the user detected by the gaze detection unit 71, for example, if the user moves his/her gaze to a subject in an action state at the timing when the subject is detected, it is determined not to restrict the change of the main subject, and otherwise it is determined to restrict it. This allows the user to use the gaze detection function to quickly determine the main subject when a scene occurs in which vertical and horizontal action occurs instantaneously during shooting of a fast-moving and complex sports competition scene.

Restriction condition 7: When a user directly sets the main subject using the touch display of the display unit 28, even if another subject in an action state is detected, it is determined that the change of the main subject to another subject is to be restricted. This is because the subject directly specified by the user is the most important subject for the user to shoot, and restricting the change of the main subject is more likely to match the user's shooting intention.

Restriction condition 8: If a subject region in an action state is detected in addition to the tracking subject, but the subject detection unit 602 does not detect the face of the subject, it is determined that the change of the main subject is to be restricted, and if a face is detected, it is determined that the change of the main subject is not to be restricted. This is because a subject without a face is highly likely to be a subject with low suitability as a main subject for a user. By suppressing the change of the main subject to a subject without a face, it is possible to select a subject in line with the user's shooting intention.

Restriction condition 9: It is determined that the change of the main subject is restricted unless the action likelihood 625 of the tracking subject falls below 90% of the threshold for determining that the subject is in an action state, and that it is not restricted after it falls below 90%. This makes it possible to restrict frequent changes of the main subject in a case where a plurality of subjects are in an action state at the same time. Note that instead of the threshold of 90%, a number multiplied by any other percentage or a number obtained by adding or subtracting a predetermined number may be used.

Restriction condition 10: In step S707, the number of joint points associated with the tracking subject is compared with the number of joint points associated with a subject area other than the tracking subject, and it is determined that the change of the main subject is to be restricted for a subject area that has fewer joint points than the tracking subject. This is because, for the user, a subject hidden by other subjects is likely to be a subject that is less suitable as a main subject. A small number of joint points means that various parts of the subject's body are not captured, so by restricting the change of the main subject to such a subject, it becomes possible to select a subject that is in line with the user's shooting intention.

Note that, instead of using joint points, various other methods may be used to determine whether part of the subject is not captured, such as a method of detecting the subject's parts.

Restriction condition 11: If the position of the tracking subject is within a predetermined area set in the center of the screen, and the position of another subject is within a predetermined area set in the periphery of the screen, it is determined that the change of the main subject to that subject is to be restricted. Conversely, if the position of the tracking subject is within a predetermined area set in the periphery of the screen, and the position of another subject is within a predetermined area set in the center of the screen, it is determined that the change of the main subject to that subject is not to be restricted. This is because, for the user, a subject that is cut off at the corner of the shooting screen is likely to be a subject that is not suitable as a main subject. Therefore, by restricting the change of the main subject to such a subject, it is possible to select a subject that is in line with the user's shooting intention.

Restriction condition 12: If the tracking subject continues to be in an action state for a predetermined period of time or more, it is determined that the change of the main subject is to be restricted. This is because, for example, for actions that continue for a relatively long period of time, such as soccer dribbling, if the change of the main subject is not restricted, there is a possibility that the main subject may frequently change to an opposing player competing for the ball. Therefore, by restricting the change of the main subject, it is possible to stably continue to select a dribbling soccer player as the main subject.

Restriction condition 13: If the subject selected as the main subject at the moment the user turns on SW1 is in an action state at the same timing, it is determined that the change of the main subject is to be restricted in the subsequent frames. This is because it is assumed that the user has started the shooting operation in response to the action of the subject, and therefore it is possible to select a subject that is in line with the user's shooting intention by not simply changing the main subject to another subject.

As described above, it is determined in step S1302 whether or not to restrict the change of the main subject by using any one of the methods of the restriction conditions 1 to 13, or a combination of the plurality of restriction conditions. If a combination of the plurality of restriction conditions results in a conflict between a decision to restrict and a decision not to restrict, a final decision may be made by setting a priority order for each restriction conditions. By determining whether or not to suppress the change of the main subject using the above restriction conditions, it is possible to change the main subject in accordance with the user's shooting intention.

### Modification

Next, an example of determining whether or not to restrict the change of the main subject by combining subject change restriction timer 631 and a part of restriction conditions 1 to 13 will be described using the flowchart in FIG. 14. Note that the steps in which the same processes are performed as those in FIG. 11 described in the first embodiment and FIG. 13 described in the second embodiment are given the same step numbers and the description thereof is omitted.

In FIG. 14, even if the subject change restriction timer 631 has not expired in step S1107, in the determination of the subject change restriction conditions in step S1302, a determination is made as to whether to restrict the change of the main subject based on any one of the restriction conditions 1 to 13. If it is not determined that the change of the main subject is to be restricted, the process proceeds from step S1303 to step S1109, and the subject with the highest priority is selected as the main subject. On the other hand, if it is determined in step S1303 that the change of the main subject is to be restricted, the change of the main subject is restricted, and the process proceeds to step S1108.

As a result, even if the subject change restriction timer has not expired, if it is determined that the main subject is to be changed, it is possible to change the main subject with high responsiveness in accordance with the user's shooting intention.

### Other Embodiments

The present invention may be applied to a system made up of a plurality of devices, or to an apparatus made up of a single device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2024-012176, filed Jan. 30, 2024, and No. 2024-066307, filed Apr. 16, 2024 which are hereby incorporated by reference herein in their entirety.

What is claimed is:

1. An electronic apparatus comprising one or more processors and/or circuitry which function as:
a first detection unit that detects one or more subjects from images obtained by performing shooting repeatedly;
a determination unit that determines whether each of the subjects detected by the first detection unit is in a predetermined motion state;
a selection unit that selects one of the subjects detected by the first detection unit as a main subject; and
a control unit that, in a case where the subject determined to be in the motion state by the determination unit is selected as the main subject by the selection unit, restricts a change of the main subject in subsequent images.

2. The electronic apparatus according to claim 1, wherein the control unit performs control so as not to change the main subject for a predetermined period of time since it is determined that the subject selected as the main subject is in the motion state.

3. The electronic apparatus according to claim 2, wherein the one or more processors and/or circuitry further function as a setting unit that sets a sensitivity of selection by the selection unit,
wherein, in a case where the sensitivity is a first sensitivity, the predetermined period is made longer than in a case where the sensitivity is a second sensitivity higher than the first sensitivity.

4. The electronic apparatus according to claim 1, wherein, in a case where the subject selected as the main subject in one image is not in the motion state and another subject in the motion state is detected in the subsequent images, the selection unit reselects the subject in the motion state as the main subject.

5. The electronic apparatus according to claim 1, wherein, in a case where the subject in the motion state selected as the main subject is not detected for a predetermined period in the subsequent images, the control unit controls to release the restriction on the change of the main subject.

6. The electronic apparatus according to claim 1, wherein, in a case where the subject in the motion state selected as the main subject moves out of a frame in the subsequent images, the control unit controls to release the restriction on the change of the main subject.

7. The electronic apparatus according to claim 1, wherein the one or more processors and/or circuitry further function as a second detection unit that detects a predetermined object associated with the motion state,
wherein the selection unit selects the main subject based on a result of a determination by the determination unit and a position of the object.

8. The electronic apparatus according to claim 7, wherein, in a case where a plurality of subjects including the subject in the motion state selected as the main subject are detected within a predetermined distance range from the object in the subsequent images, the control unit controls to restrict the change of the main subject.

9. The electronic apparatus according to claim 7, wherein, in a case where the object moves away from the subject in the motion state selected as the main subject and approaches another subject in the motion state in the subsequent images, the control unit controls not to restrict the change of the main subject to the other subject.

10. The electronic apparatus according to claim 7, wherein, in a case where a distance between the object and another subject in the motion state is shorter than the distance between the object and the subject in the motion state selected as the main subject in the subsequent images, the control unit controls not to restrict the change of the main subject to the other subject.

11. The electronic apparatus according to claim 7, wherein, in a case where the distance between the object and another subject in the motion state is greater than the distance between the object and the subject in the motion state selected as the main subject in the subsequent images, the control unit controls to restrict the change of the main subject to the other subject.

12. The electronic apparatus according to claim 1, wherein, in a case where the first detection unit detects another subject in the motion state different from the subject in the motion state selected as the main subject in the subsequent images and the other subject is framed to be at the center of a predetermined area, the control unit controls not to restrict the change of the main subject to the other subject.

13. The electronic apparatus according to claim 1 further comprising a line of sight detection unit,
wherein, in a case where the first detection unit detects another subject in the motion state different from the subject in the motion state selected as the main subject in the subsequent images and the other subject is gazed, the control unit controls not to restrict the change of the main subject to the other subject.

14. The electronic apparatus according to claim 1, wherein
the first detection unit has a unit that determines whether or not a face of each of the detected subjects exists in the image, and
in a case where the subject selected as the main subject is in the motion state and the face of another subject in the motion state is not detected, the control unit controls to restrict the change of the main subject to the other subject.

15. The electronic apparatus according to claim 1, wherein
the first detection unit has a unit that determines whether or not a body part of each of the detected subjects exists in the image, and
in a case where the subject selected as the main subject is in the motion state and a number of the parts of another subject in the motion state is less than a number of parts of the main subject by a predetermined number or more, the control unit controls to restrict the change of the main subject to the other subject.

16. The electronic apparatus according to claim 1, wherein, in a case where the subject selected as the main subject is in the motion state and the position of another subject in the motion state is within a predetermined area on periphery of the image, the control unit controls to restrict the change of the main subject to the other subject.

17. The electronic apparatus according to claim 1, wherein, in a case where the subject selected as the main subject remains in the motion state for a predetermined period of time, the control unit controls to restrict the change of the main subject to another subject in the motion state.

18. The electronic apparatus according to claim 1, wherein
the selection unit has a decision unit that decides the main subject in response to a predetermined operation by a user, and
in a case where the decision unit decides a subject in the motion state as the main subject in one image, the control unit controls to restrict the change of the main subject to another subject in the motion state in the subsequent images.

19. The electronic apparatus according to claim 1 further comprising a designation unit that is used for designating the main subject,
wherein the selection unit selects the subject selected by the designation unit as a main subject.

20. The electronic apparatus according to claim 19, wherein, in a case where the subject selected by the designation unit is selected as the main subject in one image, the control unit controls to restrict the change of the main subject to another subject in the motion state in the subsequent images.

21. The electronic apparatus according to claim 1, wherein the determination unit obtains a likelihood of the motion state for each of the subjects, and determines that an subject having a likelihood equal to or greater than a first threshold is in the motion state.

22. The electronic apparatus according to claim 21, wherein the selection unit determines a priority based on the likelihood, and selects the subject with the highest priority as the main subject.

23. The electronic apparatus according to claim 21 further comprising a tracking unit that tracks the subject selected as the main subject,
wherein the selection unit determines a priority on the result of tracking by the tracking unit and on the likelihood, and selects the subject with the highest priority as the main subject.

24. The electronic apparatus according to claim 21, wherein the determination unit obtains the likelihood based on position information of a plurality of predetermined parts of each of the subjects.

25. The electronic apparatus according to claim 21, wherein, in a case where the subject selected as the main subject is in the motion state and the likelihood of the main subject is equal to or greater than a second threshold lower than the first threshold, the control unit controls to restrict the change of the main subject.

26. The electronic apparatus according to claim 1 further comprising an imaging unit that performs shooting of each image.

27. An image processing method comprising:
detecting one or more subjects from images obtained by performing shooting repeatedly;
determining whether each of the detected subjects is in a predetermined motion state;
selecting one of the detected subjects as a main subject; and
in a case where the subject determined to be in the motion state is selected as the main subject, restricting a change of the main subject in subsequent images.

28. A non-transitory computer-readable storage medium, the storage medium storing a program that is executable by the computer, wherein the program includes program code for causing the computer to function as an electronic apparatus comprising:
a first detection unit that detects one or more subjects from images obtained by performing shooting repeatedly;
a determination unit that determines whether each of the subjects detected by the first detection unit is in a predetermined motion state;
a selection unit that selects one of the subjects detected by the first detection unit as a main subject; and
a control unit that, in a case where the subject determined to be in the motion state by the determination unit is selected as the main subject by the selection unit, restricts a change of the main subject in subsequent images.
